(19) United States
(12) Patent Application Publication
(10) Pub. No.: US 2026/0200708 A1
(43) Pub. Date: Jul. 16, 2026

(54) Autonomous Transport Vehicle with an Environmental Perception Sensor

(71) Applicant: AGCO International GmbH, Neuhausen (CH)

(72) Inventors: Niklas Völker, Marktoberdorf (DE); Daniel Turba, Marktoberdorf (DE); Johannes Zimmerer, Marktoberdorf (DE); Justus Gärtner, Marktoberdorf (DE); Markus Moskopp, Marktoberdorf (DE)

(21) Appl. No.: 19/136,269

(22) PCT Filed: Nov. 23, 2023
(86) PCT No.: PCT/IB2023/061840

§ 371 Date: Jun. 5, 2025

(30) Foreign Application Priority Data
Dec. 5, 2022 (GB) 2218208.3

(51) Int. Cl. B66F 9/06; B66F 9/075; B66F 17/00

(52) U.S. Cl. CPC B66F 9/063; B66F 9/0755; B66F 17/00

(57) ABSTRACT

An autonomous transport vehicle for transporting an object has a platform, a first environmental perception sensor mounted at the platform for detecting an object located in the vicinity of the autonomous transport vehicle and a lifting device being moveable in a vertical direction relative to the platform for lifting an object from a ground. The platform comprises a first clearance. The first environmental perception sensor has a first sensing range extending at least partly through the first clearance for covering a first intersection point located in front of a main part of the platform on a longitudinal axis of the autonomous transport vehicle. A related method is also disclosed.

### FIELD

The present disclosure relates generally to an autonomous guided vehicle (AGV) or autonomous mobile robot (AMR) for transporting objects, in the following described as an autonomous transport vehicle or AGV. The autonomous transport vehicle may have a lifting device to pick up and carry an object and to deploy the object at a specific location.

### BACKGROUND

U.S. patent application US 2022/0063979 A1, entitled “Automatic guided vehicle (AGV)”, published Mar. 3, 2022, discloses a lift truck automatic guided vehicle (AGV) with a chassis, a casing, a front lifting system and a left and right safety laser scanner. The laser scanners are attached to angled frames at a rear side of the AGV opposite to the front lifting system. The laser scanners may scan a region behind the AGV but they may not scan a region directly in front of the front lifting system since the sensing range of the laser scanners is restricted by the solid casing.

Alternatively, there are autonomous fork lift vehicles with a safety sensor attached to the fork. Such forklift vehicles enable a detection of an obstacle in front of the fork. But since the fork is used to transport objects there is always a risk that the safety sensor will be damaged when the objects are picked up by the fork.

### BRIEF SUMMARY

It is an objective to improve the sensing range of an environmental perception sensor located at a rear side of an autonomous transport vehicle so that the environmental perception sensor is able to detect an object in front of the autonomous transport vehicle.

According to an aspect of the invention there is provided an autonomous transport vehicle for transporting an object comprising a platform, a first environmental perception sensor mounted at the platform for detecting an object located in the vicinity of the autonomous transport vehicle, a lifting device extending at a front side of the platform along a longitudinal axis of the autonomous transport vehicle and being moveable relative to the platform in a vertical direction for lifting an object from a ground. The platform comprises a first clearance. The first environmental perception sensor has a limited first sensing range extending at least partly through the first clearance for covering a first intersection point located in front of a main part of the platform on the longitudinal axis of the autonomous transport vehicle.

The environmental perception sensor of the autonomous transport vehicle may be mounted at the platform for detecting one or multiple objects located around the platform. The autonomous transport vehicle may be configured to move autonomously on the ground of an industrial building as a warehouse or a factory. The platform of the autonomous transport vehicle may comprise a main part and a base part. The platform may be equipped with an electric drive system and a guidance system to navigate the autonomous transport vehicle along corridors of the industrial building. The electric drive system may be integrated in the base part of the platform. The main part may be elongated in the longitudinal axis for stabilizing the autonomous transport vehicle and avoiding a rollover of the autonomous transport vehicle. The lifting device may comprise a fork to pick up an object, for example, a pallet, and to transport the object to a predefined destination. The lifting device extends along the longitudinal axis so that the extending portion, as for example the fork, may be positioned under the object for lifting it up. The lifting device may be movably attached to the main part of the platform and may be moveable along a vertical axis being perpendicular to the longitudinal axis.

The first environmental perception sensor may be configured to detect objects, as for example objects to be transported by the autonomous transport vehicle or obstacles including humans that may cause a potential collision with the autonomous transport vehicle. The first environmental perception sensor may be a camera, a LIDAR, a radar sensor, an ultrasonic sensor or any other appropriate sensor. The first environmental perception sensor may emit an electromagnetic or ultrasonic wave and may receive a reflection of the electromagnetic or ultrasonic wave to detect the presence or absence of an object within the sensing range of the first environmental perception sensor. The first sensing range of the first environmental perception sensor may be limited, for example a radius of 4 meters around the first environmental perception sensor. I.e. objects covered by the first sensing range may be detectable by the first environmental perception sensor but objects located out of the first sensing range not.

The first environmental perception sensor may be attached at an angled portion of the platform. The angled portion may be at a rear side of the platform so that the first environmental perception sensor may be at least partly oriented towards the rear side of the platform and thus a rear side of the lifting device.

The first clearance may be integrated in the platform at a similar height as the first environmental perception sensor is attached to the platform. The first clearance of the platform avoids that the first sensing range is limited by a part of the platform, e.g. a part of the housing of the platform. Hence, emitted electromagnetic or ultrasonic waves of the first environmental perception sensor may pass the platform through the first clearance and may intersect the longitudinal axis in an intersection point, e.g. the first intersection point, within the first sensing range. The first sensing range may be a horizontal plane parallel to the longitudinal axis. The edge of the first sensing range may intersect the longitudinal axis in front of the lifting device in at least one intersection point. Thus, the first sensing range extends up to the front side of the autonomous transport vehicle so that an object in front of the lifting device is detectable by the first environmental perception sensor. I.e., although the first environmental perception sensor may be oriented towards the rear side of the lifting device the first environmental perception sensor may detect objects located in front of the lifting device.

The first environmental perception sensor may have a limited first sensing range extending at least partly through the first clearance for covering a first intersection point located in front of the lifting device on the longitudinal axis of the autonomous transport vehicle.

The platform may extend in the vertical direction at a rear side of the lifting device. The more the platform may extend in the vertical direction the higher may the lifting device be lifted up in the vertical direction.

The lifting device may be moveable between a lower position and an upper position. The first intersection point may be covered by the first sensing range when the lifting device is in the lower position. So, the first sensing range is not limited by a portion of the lifting device even if the lifting device is positioned at a height level similar to a height level of the first sensing range. The first intersection point may be covered by the first sensing range when the lifting device is in the upper position as well as when the lifting device is in the lower position.

The first clearance may have at least partly an U-shaped or a V-shaped contour. The size of the U-shaped or V-shaped contour may be big enough that the first intersection point may be covered by the first sensing range. The two legs of the U-shaped or V-shaped contour may be parallel to the first sensing range extending in a horizontal plane.

The first sensing range may be limited by an outer edge and an inner edge. The outer edge of the first sensing range is limited by the maximum physical sensing capability of the first sensing range and any other things preventing an extension of the sensing range as obstacles in the vicinity of the autonomous transport vehicle. In contrast, the inner edge may be limited by parts or components of the autonomous transport vehicle itself.

An angle between the longitudinal axis and the inner edge of the first sensing range may be greater than 10 degree. For example, the angle may be any value between 12 degree and 25 degree.

Since the inner edge of the first sensing range may be limited by parts or components of the autonomous transport vehicle itself the angle between the longitudinal axis and the inner edge of the first sensing range may be limited by the (same) parts or components of the autonomous transport vehicle. The less parts or components limit the first sensing range the greater the angle between the longitudinal axis and the inner edge of the first sensing range may be. And, the greater the angle between the longitudinal axis and the inner edge of the first sensing range is the closer the first intersection point to the autonomous transport vehicle may be. I.e., the greater the angle between the longitudinal axis and the inner edge of the first sensing range is the better the sensing range may detect objects located in front of the autonomous transport vehicle.

The first clearance may have an inclination being inclined in respect of the longitudinal axis. The inclination may be in alignment with the angle between the longitudinal axis and the inner edge of the first sensing range so that the first clearance ensures that the first sensing range is not limited by any other parts or components of the autonomous transport vehicle.

The inclination of the first clearance may be oriented towards the first intersection point. Thus, it may be ensured that the first sensing range may not be limited more than necessary to cover the first intersection point. The limitation of the first sensing range may be reduced if the inclination of the first clearance is increased. Thus, the angle between the longitudinal axis and the inner edge of the first sensing range may be increased.

A distance between the first intersection point and a distal end of the lifting device in the lower position may be any value shorter than 30 centimeters. Alternatively, the distance may be any value shorter than 25 centimeters, as for example 20 centimeters. The distance between the first intersection point and the distal end of the lifting device may depend on geometrical properties of the autonomous transport vehicle as for example the angle between the longitudinal axis and the inner edge of the first sensing range, the inclination of the first clearance, etc. as mentioned above. The shorter the distance between the first intersection point and the distal end of the lifting device may be the better surveillance of the environment of the autonomous transport vehicle may be provided and the better the sensing range may detect objects located in front of the lifting device. If the first sensing range is limited by the lifting device in the lower position the first intersection point may change its position to a location under the lifting device when the lifting device is lifted up. Then, the intersection point may overlap with the autonomous transport vehicle for what reason the distance between the intersection point and the distal end of the lifting device is deemed to be zero.

The first sensing range may cover a second intersection point located behind the platform on the longitudinal axis of the autonomous transport vehicle. For example, emitted electromagnetic or ultrasonic waves of the first environmental perception sensor may intersect the longitudinal axis in another intersection point, e.g. the second intersection point, within the first sensing range. So, the edge of the first sensing range may intersect the longitudinal axis behind the platform in at least one intersection point. This means, the second intersection point is also behind the lifting device. Thus, the first sensing range extends from the front side of the autonomous transport vehicle to the rear side of the autonomous transport vehicle. Since the first environmental perception sensor may be attached at a rear side of the platform a distance between the second intersection point and the rear side of the platform may be shorter than the distance between the first intersection point and the distal end of the lifting device.

The platform may comprise at least one wheel for moving the autonomous transport vehicle on the ground. The at least one wheel may be located below and adjacent to the first clearance. The wheel may be driven by the electric drive system. If the wheel is located below the first clearance the wheel may not limit the first sensing range. The autonomous transport vehicle may comprise additional driven wheels as a second and a third wheel. At least one of the first wheel and the other wheels of the autonomous transport vehicle may be steerable.

The platform may comprise a base part extending along the longitudinal axis below the lifting device. The base part may be excluded from the first sensing range. I.e., the base part may not limit the first sensing range.

The lifting device may also be excluded from the first sensing range. I.e., the inner edge of the first sensing range may be adjacent to the lifting device but may not cover a part of the lifting device. Thus, the lifting device may not limit the first sensing range. The distal end of lifting device may also not disturb the first sensing range so that a false collision warning can be avoided.

A distal end of the lifting device may have an inclined shape correlating with the angle between the longitudinal axis and the inner edge of the first sensing range. Thus, the lifting device may be designed in such a way that the lifting device may be excluded from the first sensing range.

The autonomous transport vehicle may comprise a second environmental perception sensor mounted at the platform for detecting an object in the vicinity of the autonomous transport vehicle. The platform may comprises a second clearance. The second environmental perception sensor may have a limited second sensing range extending at least partly through the second clearance for covering the first intersection point located in front of the platform on the longitudinal axis of the autonomous transport vehicle. A combination of the first sensing range and the second sensing range may result in a surrounding sensing range around the autonomous transport vehicle.

The second environmental perception sensor may be of the same type as the first environmental perception sensor and may work according to the same working principle as described above. The second environmental perception sensor may be attached at an angled portion of the platform. The second environmental perception sensor may be opposite to the first environmental perception sensor. The angled portions to which the first and second environmental perception sensors are attached to the platform may be axis-symmetrical to the longitudinal axis. Thus, the first and second sensing range may be axis-symmetrical to the longitudinal axis. The inner edges of the first and the second sensing range may intersect both the first and second intersection point. So, the combination of the first sensing range and the second sensing range may be a gapless sensing range to detect every object in the vicinity of the autonomous transport vehicle.

The number of the environmental perception sensors may be limited to the first and the second environmental perception sensor. The more environmental perception sensors are installed the more complex and expansive the sensor system may be. Since a surrounding sensing range around the autonomous transport vehicle may be provided by two environmental perception sensors only as described above the number of the environmental perception sensors can be limited to two.

The autonomous transport vehicle may comprise a sensor device to detect if an object is carried by the lifting device. This sensor device may be a contact sensor, a weight sensor or an optical sensor, for example. The sensor device may be integrated in the lifting device.

The control unit may be configured to detect if an object is carried by the lifting device based on a current demand required to lift the object. Thus, the presence of an object carried by the lifting device can be detected without the usage of a separate sensor.

The autonomous transport vehicle may comprise a control unit configured to adjust the vertical position of the lifting device. The control unit may be integrated in the platform. The control unit may be connected with the first and second environmental perception sensor, the sensor device and the electric drive system to control the speed and the steering of the wheels. The control unit may generate control signals in response to sensor inputs provided by the first and second environmental perception sensor. The lifting device may be adjusted between a lower position and an upper position. An object may be picked up by the lifting device in the lower position and transported in a position higher than the lower position.

The control unit may be configured to reduce the speed of the autonomous transport vehicle from a higher speed value to a lower speed value if an object being free of contact with the lifting device protrudes in the first sensing range. If an object is free of contact with the lifting device this object may be an obstacle in the vicinity of the autonomous transport vehicle that may cause a collision in contrast to an object carried by the lifting device. A collision may be prevented when the speed of the autonomous is reduced at the right time, if necessary to bring the autonomous transport vehicle to standstill before a collision occurs. The speed value may be a current speed value of the autonomous transport vehicle. Alternatively, the speed value may be a maximum speed value up to which the autonomous transport vehicle can be accelerated.

The control unit may be configured to prevent a movement of the autonomous transport vehicle on the ground if an object carried by the lifting device protrudes in the first sensing range. When an object is picked up by the lifting device the autonomous transport vehicle would be in standstill. The autonomous transport vehicle may start moving again if the object has been lifted up and is carried by the lifting device. If an object is carried by the lifting device (or not) may be detected by the sensor device as described above. But the lifted object may protrude in the first sensing range so that the sensing range is reduced so that for example the first intersection point may not be covered by the first sensing range anymore. In such a case, the control unit may prevent a movement of the autonomous transport vehicle to improve safety and to restore full range of the first sensing range before starting a movement of the autonomous transport vehicle. The same may apply if an object carried by the lifting device protrudes in the second sensing range.

The control unit may be configured to adjust the vertical position of the lifting device for moving an object carried by the lifting device out of the first sensing range. The control unit may also be configured to stop the adjustment of the lifting device if the object is moved out of the first sensing range. I.e., the control unit may detect that the object carried by the lifting device protrudes in the first sensing range and may trigger the lifting device to lift the object above the planar sensing range of the environmental perception sensor. The control unit may trigger the lifting device to stop lifting the object if the full range of the first sensing range has been restored. Then, the first intersection point would be covered by the first sensing range. Finally, the control unit may enable a movement of the autonomous transport vehicle again. The same may apply if an object carried by the lifting device protrudes in the second sensing range.

Another aspect includes a method for transporting an object by an autonomous transport vehicle comprising a platform and a lifting device being moveable in a vertical direction relative to the platform for lifting an object from a ground wherein the method comprises the steps of detecting an object protruding in a first sensing range of a first environmental perception sensor, determining if the object is carried by the lifting device, reducing the speed of the autonomous transport vehicle from a higher speed value to a lower speed value if the object is free of contact with the lifting device and preventing a movement of the autonomous transport vehicle on the ground if the object is carried by the lifting device.

The speed of the autonomous transport vehicle may be the current speed or a maximum speed value. The speed may be reduced to reduce the risk of a collision between the object and the autonomous transport vehicle. The lifting device of the autonomous transport vehicle may be positioned under the object to lift it up. When the lifting device lifted up the object the control unit may check whether the first sensing range is reduced due to the lifted object. If so, the movement of the autonomous transport vehicle may be prevented to improve safety until the object has been lifted high enough to be moved out of the first sensing range. The same may apply if an object carried by the lifting device protrudes in the second sensing range.

The method may comprise additionally the steps of adjusting the vertical position of the lifting device for moving the object out of the first sensing range and enabling a movement of the autonomous transport vehicle on the ground if the object carried by the lifting device is moved out of the first sensing range.

If the object has been lifted up high enough by the lifting device the object wouldn't reduce the first sensing range anymore. Then, full range of the first sensing range could be restored. I.e. any objects in the vicinity of the autonomous transport vehicle can be reliably detected by the first environmental perception sensor. The same may apply if an object carried by the lifting device protrudes in the second sensing range.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

Several aspects of the invention will now be described, by way of example only, with reference to the accompanying drawings, in which:

FIG. 1 illustrates a top view of an autonomous transport vehicle.

FIG. 2 illustrates a rear view of the autonomous transport vehicle.

FIG. 3A illustrates a side view of the autonomous transport vehicle with a lifting device in a lower position.

FIG. 3B illustrates a side view of the autonomous transport vehicle with the lifting device in an upper position.

FIG. 4 illustrates a perspective view of the autonomous transport vehicle.

FIG. 5 illustrates a simplified view of a control unit of the autonomous transport vehicle 1.

FIG. 6 illustrates a flow chart of a method that may be carried out by the control unit of FIG. 5.

### DETAILED DESCRIPTION

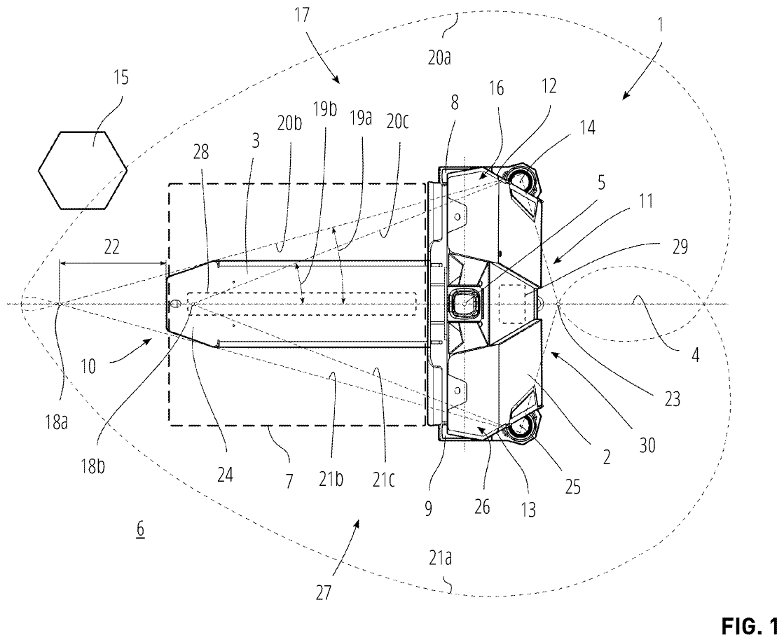

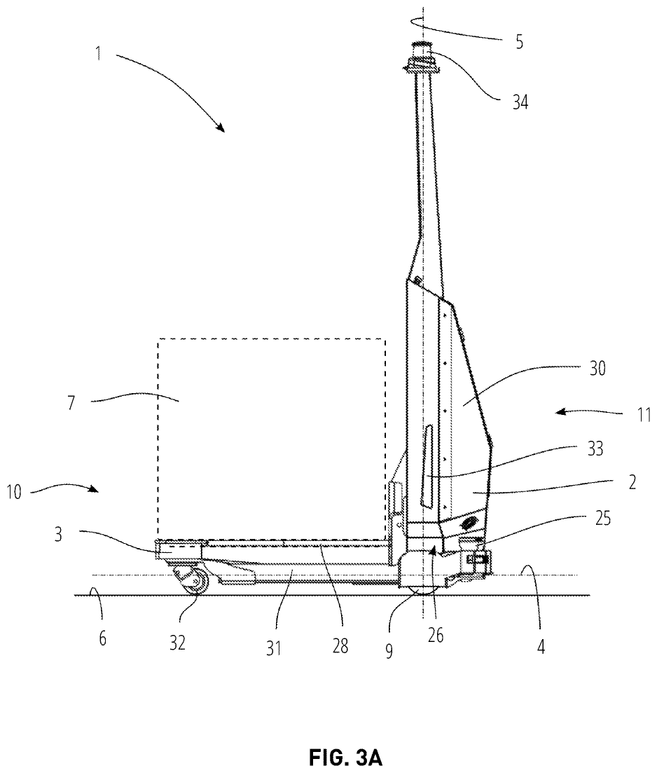

An autonomous transport vehicle 1 with a platform 2 and a lifting device 3 is shown in FIG. 1 to FIG. 4. The autonomous transport vehicle 1 has a longitudinal axis 4 and a vertical axis 5 being perpendicular to the longitudinal axis 4. A main part 30 of the platform 2 located at a rear side 11 of the autonomous transport vehicle 1 extends in the vertical direction wherein a base part 31 of the platform 2 extends along the longitudinal axis 4. The lifting device 3 extends along the longitudinal axis 4 from the main part 30 of the platform 2 to a distal end 24 at the front side 10 of the autonomous transport vehicle 1. The main part 30 comprises a light 33 for lighting up the vicinity of the autonomous transport vehicle 1. The lifting device 3 comprises a fork with a single prong. Alternatively, the lifting device 3 may have two or more prongs. The lifting device 3 is moveable relative to the platform 2 in a vertical direction along the vertical axis 5 between a lower position close to a ground 6 (see FIG. 3A) and an upper position (see FIG. 3B). The lifting device 3 can pick up an object from the ground 6, as for example object 7, and lift the object 7 up and down by adjusting the vertical position, i. e. the height, of the fork of the lifting device 3.

An electric drive system is integrated in the base part 31 of the platform 2 to provide a moveable platform 2. The moveable platform 2 has at least a wheel 8 to move the autonomous transport vehicle 1 on the ground 6. The platform 2 may be equipped with additional wheels as wheel 9 and a third wheel 32 arranged under the lifting device 3. All wheels are driven by the electric drive system. At least one of the wheels is a steerable wheel so that the autonomous transport vehicle 1 may turn to change the driving direction as for example wheel 32.

The moveable platform 2 comprises an electrical storage unit such as a battery to feed the electric drive system and a control unit 29 with electrical power. The control unit 29 is integrated in the main part 30 of the platform 2 and controls the electric drive system to accelerate, brake and steer the autonomous transport vehicle 1. Additionally, the control unit 29 is configured to adjust the vertical position of the lifting device 3. For example, the control unit 29 may control an electric motor or an electrohydraulic piston connected with the prong to move the lifting device 3 between the lower and the upper position.

The platform 2 comprises a first angled portion 12 and a second angled portion 13 at a rear side 11 of the autonomous transport vehicle 1. As can be seen in FIG. 1, the angled portions 12 and 13 are oriented differently but they are axis-symmetrical to the longitudinal axis 4. A first environmental perception sensor 14 of the autonomous transport vehicle 1 is attached to the first angled portion 12. A second environmental perception sensor 25 of the autonomous transport vehicle 1 is attached to the second angled portion 13. So, the first environmental perception sensor 14 is at least partly oriented towards the rear side 11 of the platform 2 according to the orientation of the first angled portion 12 and the second environmental perception sensor 25 is at least partly oriented towards the rear side 11 of the platform 2 according to the orientation of the second angled portion 13.

The first and second environmental perception sensors 14 and 25 are configured to detect an object located in the vicinity of the autonomous transport vehicle 1. The first environmental perception sensor 14 has a first sensing range 17 limited by an edge 20 comprising an outer edge 20a and an inner edge 20b or inner edge 20c. The outer edge 20a is limited due to a maximum physical sensing capability of the first environmental perception sensor 14. I.e., the first environmental perception sensor 14 may emit electromagnetic or ultrasonic waves depending on the type of the first environmental perception sensor 14 for detecting the object wherein the emitted waves may reach up to the outer edge 20a. Additionally, the first sensing range 17 is limited by the inner edge 20b or inner edge 20c depending on whether the lifting device 3 is in the lower or in the upper position. As can be seen in FIG. 1, the inner edge 20c is limited due to the design of the platform 2 if the lifting device 3 is in the upper position whereas the inner edge 20b is limited due to the design of the platform 2 and the distal end of the lifting device 3 if the lifting device 3 is in the lower position.

Analogously to the first environmental perception sensor 14, the second environmental perception sensor 25 has a second sensing range 27 limited by an outer edge 21a and an inner edge 21b or inner edge 21b. The first and second sensing ranges 17 and 27 may be each horizontal planes parallel to the longitudinal axis 4. The horizontal planes of the first and second sensing ranges 17 and 27 may be coplanar. As shown in FIG. 1, the first sensing range 17 and the second sensing range 27 are complement to a surrounding sensing range around the autonomous transport vehicle 1 in terms of a closed sensing range defined by the outer edges 20a and 21a of the first and second sensing range 17 and 27. Regardless from which direction an object 15 may approach the autonomous transport vehicle 1 the object 15 will be detected by the first or the second environmental perception sensor 14 or 25. Hence, it would be sufficient to equip the autonomous transport vehicle 1 with only two environmental perception sensors 14 and 25 for a full environmental perception functionality. Nevertheless, it is still possible to implement more than two environmental perception sensors, e.g. to design a redundant sensor system for an enhanced safety functionality by means of safety sensor 34 mounted on top of the main part 30 (see FIG. 3A or FIG. 3B).

The object may be an object 7 to be picked up and transported by the autonomous transport vehicle 1 as for example a pallet or an obstacle 15 that may cause a collision with the autonomous transport vehicle 1. Any object will be detected by the first environmental perception sensor 14 if the object gets into the first sensing range 17 (as for example object 15 in FIG. 1) or by the second environmental perception sensor 25 if the object gets into the second sensing range 27. In case of a detected object, the control unit 29 receives from the first or second environmental perception sensor 14 or 25 a signal and may trigger in response to that signal a safety function as slowing down or stopping the autonomous transport vehicle 1 for example.

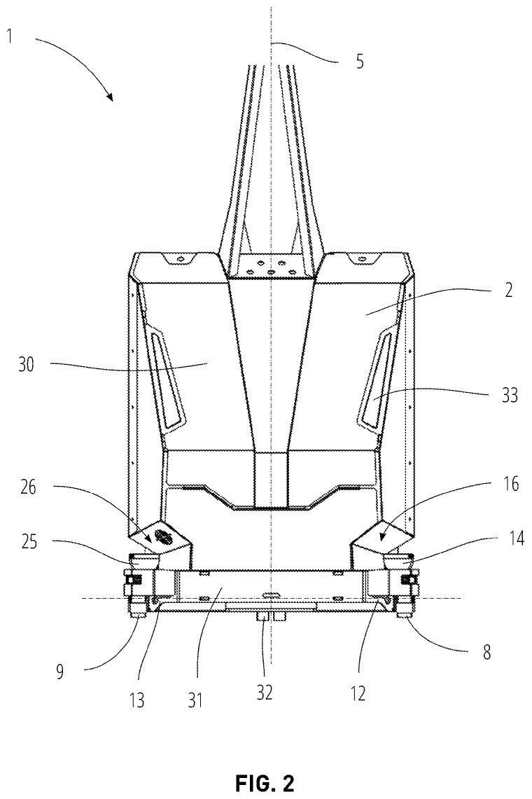

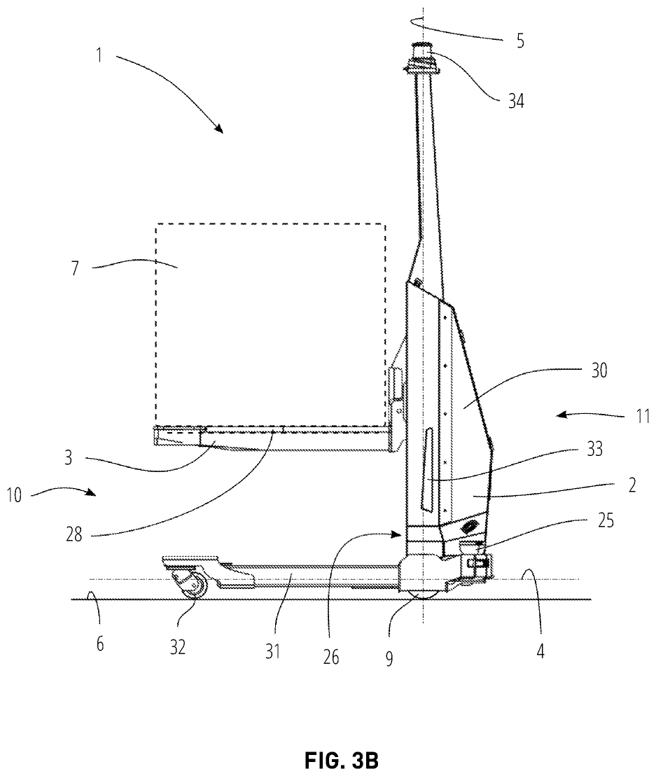

As can be seen also in FIG. 2 and FIG. 4, the platform 2 comprises a first clearance 16 extending from a rear side 11 at which the first environmental perception sensor 14 is located to a front side 10 of the autonomous transport vehicle 1. The first clearance 16 is at the same height of the first environmental perception sensor 14 so that the first sensing range 17 extends at least partly through the first clearance 16. Analogously, the platform 2 comprises a second clearance 26 extending from the rear side 11 at which the second environmental perception sensor 25 is located to the front side 10 of the autonomous transport vehicle 1. The second clearance 26 is at the same height of the second environmental perception sensor 25 so that the second sensing range 27 extends at least partly through the second clearance 26. I.e., waves emitted by the first or second environmental perception sensor are able to pass the platform 2 through the first or second clearance 16 or 26.

As can be seen in FIG. 1 and FIG. 2, the first clearance 16 and the second clearance 26 are axis-symmetrical to the longitudinal axis 4. The first clearance 16 is inclined in respect of the longitudinal axis 4 and oriented towards a first intersection point 18a located in front of the lifting device 3, when the lifting device 3 is in the lower position and oriented towards a first intersection point 18b located under the lifting device 3, when the lifting device 3 is in the upper position. Thus, on the one hand the inner edge 20b of the first sensing range 17 can intersect the longitudinal axis 4 in a first intersection point 18a if the lifting device 3 is in the lower position and on the other hand intersect the longitudinal axis 4 in a first intersection point 18b if the lifting device 3 is in the upper position.

Analogously, the second clearance 26 is inclined in respect of the longitudinal axis 4 and oriented towards the first intersection point 18a or the first intersection point 18b depending on the position of the lifting device 3 so that on the one hand the inner edge 21b of the second sensing range 27 can also intersect the longitudinal axis 4 in the same first intersection point 18a and on the other hand the inner edge 21c of the second sensing range 27 can also intersect the longitudinal axis 4 in the same first intersection point 18b. Hence, the first intersection point 18a or the first intersection point 18b are covered by the first sensing range 17 as well as by the second sensing range 27 depending on the position of the lifting device 3.

As can also be seen in FIG. 1, the more the first clearance 16 is inclined the more an angle 19a between the longitudinal axis 4 and the edge 20b of the first sensing range 17 increases. Consequently, the more the angle 19a increases the closer the first intersection point 18a will be to the distal end 24 of the lifting device 3 and the shorter a distance 22 between the first intersection point 18a and the distal end 24 will be. Since a shorter distance 22 reduces a non-observable area in front of the distal end 24 the surveillance of the environment of the autonomous transport vehicle 1 can be improved. For example, the angle 19a between the longitudinal axis 4 and the inner edge 20b of the first sensing range 17 can be greater than 10 degree or the distance 22 between the first intersection point 18a and the distal end 24 of the lifting device 3 can be shorter than 25 centimeters.

If the lifting device 3 is in the upper position the first and the second sensing ranges 17 and 27 are not limited by the lifting device 3. Thus, the first intersection point 18b changes its position under the lifting device 3 which results in an angle 19b between the longitudinal axis 4 and the inner edge 20c of the first sensing range 17 being greater than angle 19a.

The base part 31 of the platform 2 is excluded from the first sensing range 17 as well as from the second sensing range 27. I.e., the first sensing range 17 and the second sensing range 27 are not limited by the base part 31 since no part of the base part 31 protrudes into the first or second sensing range 17 or 27.

The distal end 24 of the lifting device 3 has an inclined shape correlating with the angle 19a between the longitudinal axis 4 and the inner edge 20b of the first sensing range 17. I.e., the design of the lifting device 3 is adapted to the inner edge 20b of the first sensing range 17. Analogously, the design is also adapted to the inner edge 21b of the second sensing range 27. Thus, the first intersection point 18a is covered by the first and second sensing range 17 and 27 when the lifting device 3 is in the lower position as well as when the lifting device 3 is in the upper position or a position therebetween.

The first clearance 16 and the second clearance 26 have at least partly an U-shaped contour. But also other shapes are possible as for example a V-shaped contour. The legs of the U-shaped contour may be integrated in a component of the platform 2. The length of the legs of the U-shaped may influence the value of the angle 19a or angle 19b. So for example, longer legs of the U-shaped contour of the first clearance 16 may result in a greater angle 19a between the longitudinal axis 4 and the inner edge 20b of the first sensing range 17 or a greater angle 19b between the longitudinal axis 4 and the inner edge 20c of the first sensing range 17. So, the design of the first clearance 16 influences the distance 22 being dependent from the angle 19a as well as the position of the first intersection point 18b. Same applies to the second clearance 26.

The U-shaped contour of the first clearance 16 is in alignment with the first environmental perception sensor 14 so that the first environmental perception sensor 14 is arranged between the legs of the U-shaped contour of the first clearance 16. I.e., an upper leg of the U-shaped contour is above the first environmental perception sensor 14 and a lower leg is below the first environmental perception sensor 14. Same applies to the second environmental perception sensor 25 and the second clearance 26.

As shown in FIG. 2 and FIG. 4, the wheel 8 is arranged below and adjacent to the first clearance 16. Analogously, the wheel 9 is arranged below and adjacent to the second clearance 26. So, neither the wheel 8 nor the wheel 9 limit the first or the second clearance 16 or 26.

Next to the first intersection point 18a or 18b, the first and the second sensing range 17 and 27 cover also a second intersection point 23 located behind the platform 2 on the longitudinal axis 4 of the autonomous transport vehicle 1 due to electromagnetic or ultrasonic waves emitted by the first and second environmental perception sensors 14 and 25 intersecting the longitudinal axis 4 at the second intersection point 23. As can be seen in FIG. 1, a distance between the second intersection point 23 and the rear side 11 of the autonomous transport vehicle 1 is much shorter than the distance 22 between the front side 10 auf the autonomous transport vehicle 1 and the first intersection point 18a or 18b. Whereas the first and the second intersection points 18a, 18b and 23 are intersected by the inner edges 20b, 20c and 21b of the first and second sensing range 17 and 27, there are additional intersection points where the outer edges 20a and 20b of the first and second sensing ranges 17 and 27 intersect the longitudinal axis 4. But the first intersection point 18a respectively 18b is the closest intersection point at the front side 10 of the autonomous transport vehicle 1 and the second intersection point 23 is the closest intersection point at the rear side 11 of the autonomous transport vehicle 1.

The lifting device 3 comprises a sensor device 28 to detect if an object 7 is carried by the lifting device 3. The sensor device 28 may be a sensor to detect the presence or absence of the object 7. Alternatively, the sensor device 28 may be a weight sensor to detect not only the presence but also the weight of the object 7.

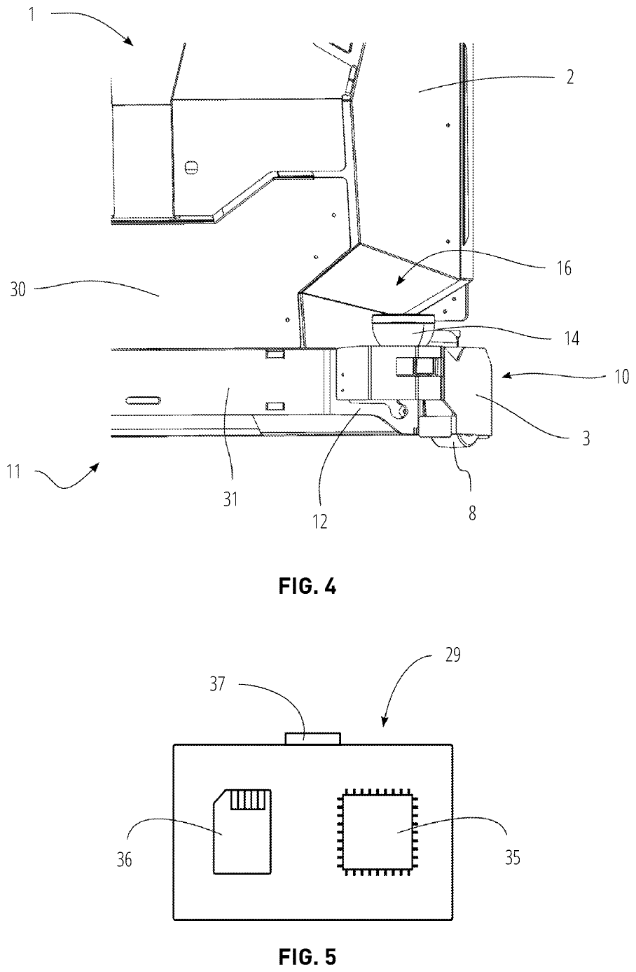

FIG. 5 shows the control unit 29 comprising an interface 37, a controller 35 and a memory 36. The control unit 29 may receive and send signals or data via the interface 37. The interface 37 may be a wireless interface or a connector. The controller 35 may store the data or signals received by the control unit 29 in the memory 36. The memory 36 may contain additional data or executable computer program products, for example in terms of a computer-implemented method, that may be retrieved, processed or carried out by the controller 35. Data or signals resulting from the processing of data or signals or from the execution of a computer program product may be stored to the memory 36 or sent to the control unit 29 by the controller 35.

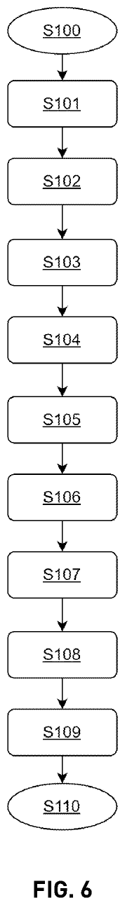

FIG. 6 shows a flow diagram of a method for transporting an object 7 by an autonomous transport vehicle 1 as described above. The method may be a computer-implemented method stored as a computer program product in the memory 36 of the control unit 29. The control unit 29 is configured to carry out the method that may be executed by the controller 35. The method is described by way of example of several steps without any restriction in respect of that steps. I.e. the number or the order of steps may be adapted, for example single steps may be excluded and/or added and executed earlier or later than described.

The control unit 29 starts the method of FIG. 6 with step S100. It is assumed now that the autonomous transport vehicle 1 is unloaded and moves on the ground 6 for approaching an object 7 to be picked up by the lifting device 3 of the autonomous transport vehicle 1. At a certain point, the object 7 will protrude in the first sensing range 17. Then, the method proceeds to step S101 at which the control unit 29 detects the object 7 protruding in the first sensing range 17 of the first environmental perception sensor 14. The captured sensor information of the first environmental perception sensor 14 is received by the control unit 29.

The method proceeds to step S102 and the control unit 29 determines if the object 7 is carried by the lifting device 3 (or not). Since the autonomous transport vehicle 1 is unloaded and the object 7 hasn't been picked up by the lifting device 3 the control unit 29 receives from the sensor device 28 that the lifting device 3 is free from any object and consequently doesn't carry object 7.

The method proceeds to step S103 and the control unit 29 reduces the speed of the autonomous transport vehicle 1 from a higher speed value to a lower speed value if the object 7 is free of contact with the lifting device 3 protruding in the first sensing range 17. The speed value may be a current speed value or a maximum allowed speed value. Thus, the autonomous transport vehicle 1 approaches the object 7 with reduced speed as long as the object 7 hasn't been picked up to avoid a collision and to improve maneuverability to position the lifting device 3 under the object 7.

The method proceeds to step S104 and the control unit 29 positions the lifting device 3 under the object 7 for lifting it up.

When the lifting device 3 is positioned under the object 7, the method proceeds to step S105 and the control unit 29 controls the lifting device 3 to move up in a vertical direction for picking up the object 7 and for lifting the object 7 from the ground 6. Then, the control unit 29 receives from the sensor device 28 the information that the lifting device 3 carries an object, here object 7.

The method proceeds to step S106 and the control unit 29 determines whether the object 7 is still protruding in the first sensing range 17. As long as the object 7 picked up by the lifting device 3 protrudes in the first sensing range 17 the first sensing range 17 is limited and the control unit 29 may be prevented to detect any other objects, as object 15, in front of the distal end 24 of the lifting device 3.

The method proceeds to step S107 and the control unit 29 prevents a movement of the autonomous transport vehicle 1 on the ground 6 if the object 7 carried by the lifting device 3 protrudes in the first sensing range 17.

The method proceeds to step S108 and the control unit 29 adjusts the vertical position of the lifting device 3 for moving the object 7 carried by the lifting device 3 out of the first sensing range 17. When the object 7 is moved out of the first sensing range 17 the control unit 29 receives a corresponding signal form the first environmental perception sensor 14. Then, the control unit 29 stops the adjustment of the lifting device 3.

Finally, if the object 7 carried by the lifting device 3 has been moved out of the first sensing range 17, the method proceeds to step S109 and the control unit 29 enables a movement of the autonomous transport vehicle 1 on the ground 6. The control unit 29 may move the autonomous transport vehicle 1 to a destination point at which the object 7 shall be deployed.

The method proceeds to step S110 and ends. The method may be restarted again by the control unit 29 at any time.

For the case that the object 7 protrudes in the second sensing range 27 and is detected by the second environmental perception sensor 25 at step S101 instead of the first environmental perception sensor 14, the following steps of the method are carried out analogously based on the sensor information of the second environmental perception sensor 25.

All references cited herein are incorporated herein in their entireties. If there is a conflict between definitions herein and in an incorporated reference, the definition herein shall control.

### LISTING OF DRAWING ELEMENTS

1 autonomous transport vehicle
2 platform
3 lifting device
4 longitudinal axis
5 vertical axis
6 ground
7 object
8 wheel
9 wheel
10 front side
11 rear side
12 angled portion
13 angled portion
14 first environmental perception sensor
15 object
16 first clearance
17 first sensing range
18a first intersection point
18b intersection point
19a angle
19b angle
20a edge
20b edge
20c edge
21a edge
21b edge
21c edge
22 distance
23 second intersection point
24 distal end
25 second environmental perception sensor
26 second clearance
27 second sensing range
28 sensor device
29 control unit
30 main part
31 base part
32 wheel
33 light
34 safety sensor
35 controller
36 memory
37 interface

1. An autonomous transport vehicle for transporting an object, comprising
a platform;
a first environmental perception sensor mounted at the platform for detecting an object located in the vicinity of the autonomous transport vehicle;
a lifting device extending at a front side of the platform along a longitudinal axis of the autonomous transport vehicle and being moveable relative the platform in a vertical direction for lifting an object from a ground; wherein
the platform comprises a first clearance and
the first environmental perception sensor has a limited first sensing range extending at least partly through the first clearance for covering a first intersection point located in front of a main part of the platform on the longitudinal axis of the autonomous transport vehicle.

2. The autonomous transport vehicle of claim 1, wherein
the first environmental perception sensor has a limited first sensing range extending at least partly through the first clearance for covering a first intersection point located in front of the lifting device on the longitudinal axis of the autonomous transport vehicle.

3. The autonomous transport vehicle of claim 1, wherein the platform extends in the vertical direction at a rear side of the lifting device.

4. The autonomous transport vehicle of claim 1, wherein
the lifting device is moveable between a lower position and an upper position; and
the first intersection point is covered by the first sensing range when the lifting device is in the lower position.

5. The autonomous transport vehicle of claim 1, wherein the first clearance has at least partly a U-shaped or a V-shaped contour.

6. The autonomous transport vehicle of claim 1, wherein an angle between the longitudinal axis and an edge of the first sensing range is greater than 12 degrees.

7. The autonomous transport vehicle of claim 1, wherein the first clearance has an inclination being inclined in respect of the longitudinal axis.

8. The autonomous transport vehicle of claim 7, wherein the inclination of the first clearance is oriented towards the first intersection point.

9. The autonomous transport vehicle of claim 1, wherein a distance between the first intersection point and a distal end of the lifting device in a lower position is shorter than 30 centimeters.

10. The autonomous transport vehicle of claim 1, wherein the first sensing range covers a second intersection point located behind the platform on the longitudinal axis of the autonomous transport vehicle.

11. The autonomous transport vehicle of claim 1, wherein the platform comprises at least one wheel for moving the autonomous transport vehicle on the ground;
the at least one wheel being located below and adjacent to the first clearance.

12. The autonomous transport vehicle of claim 1, wherein the platform comprises a base part extending along the longitudinal axis below the lifting device;
the base part being excluded from the first sensing range.

13. The autonomous transport vehicle of claim 1, wherein the lifting device is excluded from the first sensing range.

14. The autonomous transport vehicle of claim 6, wherein the lifting device is excluded from the first sensing range and wherein a distal end of the lifting device has an inclined shape correlating with the angle between the longitudinal axis and the edge of the first sensing range.

15. The autonomous transport vehicle of claim 1, comprising
a second environmental perception sensor mounted at the platform for detecting an object in the vicinity of the autonomous transport vehicle; wherein
the platform comprises a second clearance;
the second environmental perception sensor has a limited second sensing range extending at least partly through the second clearance for covering the first intersection point located in front of the platform on the longitudinal axis of the autonomous transport vehicle; and wherein
a combination of the first sensing range and the second sensing range results in a surrounding sensing range around the autonomous transport vehicle.

16. The autonomous transport vehicle of claim 15, wherein the number of the environmental perception sensors is limited to the first and the second environmental perception sensor.

17. The autonomous transport vehicle of claim 1, comprising a sensor device to detect if an object is carried by the lifting device.

18. The autonomous transport vehicle of claim 1, wherein the control unit is configured to detect if an object is carried by the lifting device based on a current demand required to lift the object.

19. The autonomous transport vehicle of claim 1, comprising a control unit configured to adjust the vertical position of the lifting device.

20. The autonomous transport vehicle of claim 19, wherein the control unit is configured to reduce the speed of the autonomous transport vehicle from a higher speed value to a lower speed value if an object being free of contact with the lifting device protrudes in the first sensing range.

21. The autonomous transport vehicle of claim 19, wherein the control unit is configured to prevent a movement of the autonomous transport vehicle on the ground if an object carried by the lifting device protrudes in the first sensing range.

22. The autonomous transport vehicle of claim 1, wherein the control unit is configured
to adjust the vertical position of the lifting device for moving an object carried by the lifting device out of the first sensing range; and
to stop the adjustment of the lifting device if the object is moved out of the first sensing range.

23. A method for transporting an object by an autonomous transport vehicle comprising a platform and a lifting device being moveable in a vertical direction relative to the platform for lifting an object from a ground, the method comprising the steps:
detecting an object protruding in a first sensing range of a first environmental perception sensor;
determining if the object is carried by the lifting device;
reducing the speed of the autonomous transport vehicle from a higher speed value to a lower speed value if the object is free of contact with the lifting device; and
preventing a movement of the autonomous transport vehicle on the ground the object is carried by the lifting device.

24. The method of claim 23, comprising the steps:
adjusting the vertical position of the lifting device for moving the object out of the first sensing range; and
enabling a movement of the autonomous transport vehicle on the ground if the object carried by the lifting device is moved out of the first sensing range.
